(19) United States
(12) Patent Application Publication
(10) Pub. No.: US 2024/0403896 A1
(43) Pub. Date: Dec. 5, 2024

(54) METHOD TO ASSESS GREEN INFRASTRUCTURE PERFORMANCE

(71) Applicant: MORGAN STATE UNIVERSITY, Baltimore, MD (US)

(72) Inventors: James G. Hunter, Bowie, MD (US); Ida Mougang Yanou, Upper Marlboro, MD (US)

(21) Appl. No.: 18/786,008

(22) Filed: Jul. 26, 2024

Related U.S. Application Data
(63) Continuation-in-part of application No. 18/734,702, filed on Jun. 5, 2024.
(60) Provisional application No. 63/529,129, filed on Jul. 26, 2023.
(60) Provisional application No. 63/471,090, filed on Jun. 5, 2023.

(51) Int. Cl. G06Q 30/018; H04N 7/18

(52) U.S. Cl. CPC G06Q 30/018; H04N 7/183

(57) ABSTRACT

A cost-effective, efficient, and innovative method for measuring green infrastructure performance of the invention integrates a database of quantitative standard values, camera drones for aerial capture of plant information, manual observation, measurement and assessment, a communications system to collect data from remote sensors, and powerful computational algorithms assisted by machine learning and fuzzy logic to generate a reliable and reproducible score reflecting the health and viability of green infrastructure, as well as recommendations for the improvement and/or maintenance of the green infrastructure.

### CROSS-REFERENCE TO RELATED APPLICATIONS

This application is based upon and claims the benefit of U.S. Provisional Application No. 63/471,090 titled “Method to Inspect and Evaluate a Green Infrastructure System,” filed with the United States Patent & Trademark Office (USPTO) on Jun. 5, 2023, U.S. Provisional Application No. 63/529,129 titled “Method to Assess Green Infrastructure Performance,” filed with the USPTO on Jul. 26, 2023, and U.S. Non-Provisional application Ser. No. 18/734,702, filed with the USPTO on Jun. 5, 2024, the specification of which are incorporated herein by reference in their entirety.

### FIELD OF THE INVENTION

The invention relates to systems and methods for evaluating green infrastructure performance.

### BACKGROUND OF THE INVENTION

Rapid urbanization, aging infrastructure, and climate change impacts have put a stress on existing stormwater drainage systems, and one commonly used solution to solve these challenges is green infrastructure. Green infrastructures (GI), also known as low impact development (LID), are ecological engineered practices with the main aim to holistically address the impacts of urban development and provide management of stormwater, through the preservation, restoration and creation of functional green space using soils, vegetation, and rainwater harvest techniques. Green infrastructures include urban agriculture, green walls, urban woodlands, suburban street trees, sensitive urban design, green roofs, parks, gardens, golf courses, and city street trees. Many green infrastructures are specifically directed to stormwater management, including bioretention areas, rain gardens, bioswales, green roofs, permeable pavements, green spaces, and wetlands, all of which utilize vegetation, substrate (or media), soils, and natural processes. Green infrastructures have numerous environmental, social, and economic benefits, including stormwater-runoff reduction, air-quality improvement, heat-island-effect reduction, carbon storage and sequestration, resilience of drainage-system improvement, pollutant reduction, water-quality improvement, urban beautification, land-value increment, and energy-demand reduction. Consequently, there is a global surge in interest and implementation of green infrastructures aimed at mitigating adverse impacts such as flooding, waterway contamination, and stream degradation. This is achieved by disconnecting the expanding impervious surfaces such as pavements and rooftops in the cities from the storm sewer systems.

The effectiveness of green stormwater infrastructures is contingent upon several factors, including plant traits (e.g., plant density), plant health, plant species, soil properties, media types, and retention time. Traditionally, monitoring these factors relied on ground-level observation and analysis. Manual observation in the field is labor-intensive and disruptive, rendering it impractical for large-scale assessments, and the analysis is inconsistent and unreliable, lacking any type of standards or standardization.

### SUMMARY OF THE INVENTION

The green infrastructure inspection and evaluation system of the invention is an innovative, efficient, economical, easy, rapid, and high accuracy inspection and evaluation method for automatically generating a score for the health and viability of a green infrastructure instead of using traditional manual check lists.

More specifically, the present invention is directed to an apparatus, system and method that provides quantitative metrics and sub-metrics to assess green infrastructure/low impact development impacts. Additionally, the present invention can be used to generate more quantified and visually revealing results with respect to the inspection of green infrastructure.

The invention has multiple applications, including guidance to establish and implement green infrastructure performance verification protocols, adaptive management that assure desired long-term outcomes while reducing the uncertainty found in natural systems and human behaviors, and providing proper inspection and maintenance schedules to extend green infrastructure life cycle. Ultimately, the invention will improve new green infrastructure design and significantly improve ongoing maintenance of existing green infrastructures.

Accordingly, there is presented according to the invention a computer-implemented system for assessment of green infrastructure including an unmanned aerial vehicle (UAV) equipped with an image capture device, a plurality of remote detection instruments located in one or more green infrastructures configured to detect one or more of air temperature, air humidity, air quality, air composition, soil composition, soil temperature, soil moisture, and soil pH, a user interface, a computing device in electronic communication with the UAV, the image capture device, one or more of the remote detection instruments, the computing device including at least one processor and at least one non-transient memory, the non-transient memory including: a standards database including state and federal regulations pertaining to green infrastructures, scientific publications pertaining to green infrastructures, and a set of green infrastructure evaluation rules that associate green infrastructure metric conditions with a positive or negative effect on green infrastructure health, an image processing module including computer readable instructions which when executed by the at least one processor generate a raw plant health score and a raw plant density score, a moisture detection data processing module including computer readable instructions which when executed by the at least one processor generate a raw moisture score, a soil quality data processing module including computer readable instructions which when executed by the at least one processor generate a raw soil quality score, an air quality data processing module including computer readable instructions which when executed by the at least one processor generate a raw air quality score, a score matrix S which relates a plurality of final green infrastructure scores to a corresponding set of green infrastructure evaluation sets, a green infrastructure improvement and maintenance database, including a set of green infrastructure improvement and maintenance rules that associate the green infrastructure evaluation sets and/or the final green infrastructure scores to a corresponding set of green infrastructure improvement and maintenance recommendations, a management module, including computer readable instructions which when executed by the at least one processor: cause the user interface to prompt the user to enter one or more green infrastructures for evaluation, cause the at least one processor to transmit a location for the selected green infrastructure to the image capture device, cause the image capture device to transmit captured images to the image processing module, cause an soil detection instrumentation to transmit soil data to the soil detection data processing module, cause an moisture detection instrumentation to transmit moisture data to the moisture detection data processing module, and/or cause an air quality detection instrumentation to transmit air quality data to the air quality detection data processing module, calculates a weighted green infrastructure evaluation matrix B using the raw plant health score, the raw plant density score, the raw moisture score, the raw soil quality score, and the raw air quality score, and the standards database, assigns a green infrastructure score using the green infrastructure evaluation matrix and the score matrix S, transmits or displays the green infrastructure score to a user device, and transmits or displays to the user device one or more of the green infrastructure improvement and maintenance recommendations. The computing device may include a network of distributed processors and non-transient memories.

As used herein, the term “module” refers to one or more lines of code. The lines of code may be custom authored code, commercially available code, and/or combinations thereof.

### BRIEF DESCRIPTION OF THE DRAWINGS

The numerous advantages of the present invention may be better understood by those skilled in the art by reference to the accompanying drawings in which:

FIG. 1 is a schematic diagram of a green infrastructure assessment and scoring system according to an embodiment of the invention.

FIG. 2 is a representation of data collection using a unmanned aerial vehicle UAV-based camera according to an embodiment of the invention.

FIG. 3 is an example of a visual representation of the health or viability of various aspects of a green infrastructure according to an embodiment of the invention.

FIG. 4 is another example of a visual representation of the health or viability of various aspects of a green infrastructure according to an embodiment of the invention.

### DETAILED DESCRIPTION OF THE INVENTION

The cost-effective, efficient, and innovative green infrastructure inspection and evaluation system of the invention integrates a database of quantitative standard values, camera drones for aerial capture of plant information, manual observation, measurement and assessment, and powerful computational algorithms assisted by machine learning and fuzzy logic to generate a reliable and reproducible score reflecting the health and viability of green infrastructure, as well as recommendations for the improvement and/or maintenance of the green infrastructure.

A key performance metric is the establishment and survivability of the GI vegetation. The performance of the GI systems to establish successful vegetative cover is attributed to adequate design, proper installation, proper plant selection, soil media function, and routine maintenance. Inadequate design, installation, and/or poor post-construction maintenance may promote poor plant establishment; reduced plant coverage; low seed, plug, or gallon plant establishment; and the colonization of pioneer, invasive, and/or noxious plant species. The lack of a robust vegetative cover can likely result in significantly reduced nutrient/pollutant removal, as the GI “ecosystem” may be reflective of poorly maintained, “unhealthy” soils.

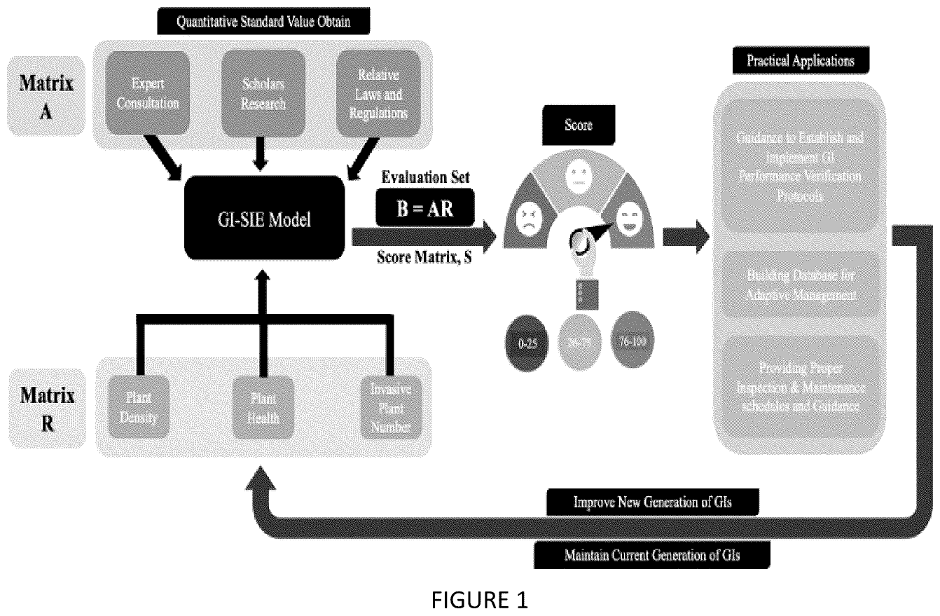

With reference to FIG. 1, the invention features a standards database containing information relevant to the evaluation of green infrastructures, including federal, state, and local regulations concerning the structure, content, location and performance of green infrastructures, journal articles and other scholarly publications or independent research concerning elements that contribute to the success and/or failure of green infrastructure, and a set of if/then-type rules (for example, if soil type is x, then bias soil score −1), also concerning elements that contribute to the success and/or failure of green infrastructures, the rules preferably established by green infrastructure experts.

Together, the data in the standards database is represented in a standards matrix A that is used to evaluate/score the data collected from selected green infrastructures.

The invention further features a critical factor database in which data collected from various green infrastructures relating to green infrastructure performance such as plant density percentages, plant health condition, and invasive plant numbers (R={r1, r2, . . . , rn}) is stored. This data is represented in a green infrastructure matrix R that is evaluated against the standards matrix A (also referred to hereinbelow as the weight coefficient set A) to generate a score B for a selected green infrastructure.

Table 1 describes five examples of metrics r that may be scored and used to build matrix R according to various embodiments of the invention, including vegetation, soil, ecosystem components, landscape design, and engineering design components.

TABLE 1
Metrics for green infrastructure/LID assessment

| Vegetation | Soil | Ecosystem | Landscape Design | Engineering Design |
|---|---|---|---|---|
| Density | Infiltration | Pollinators | Design Intent | Control Inflow/Outflow |
| Species Health | Respiration | Biodiversity | Current Aesthetics | Boundary Integrity |
| Invasives | Media/Mulch | Value Added | Hardscapes | Water Quality/Sediment |

Among these metrics several of them can be detected through automated or semi-automated systems, including drones, moisture detection instrumentation, soil type/composition/quality instrumentation, water/moisture instrumentation, air quality instrumentation, air composition instrumentation, air humidity instrumentation, pollutant/contaminant detection instrumentation, and/or light detection instrumentation. These sensors and detection instrumentation may be configured to communicate with a management module wirelessly. Metrics such as landscape and/or engineering design can be mined through data mining of state or county permit offices. Where data mining for such information fails to be fruitful, landscape and engineering design may be input manually via user-input device(s). Other metrics can be derived from inspections and proposed evaluations.

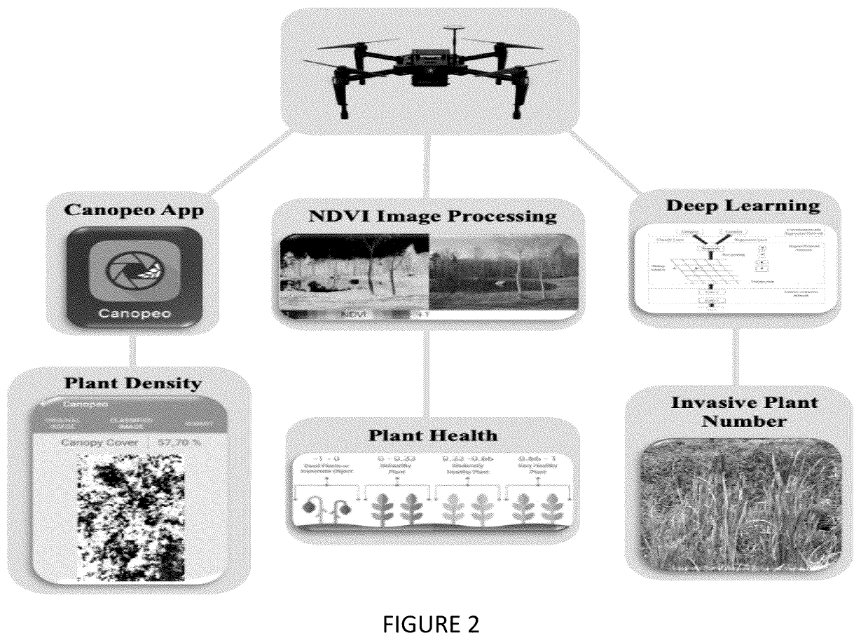

As shown in FIG. 2, an unmanned aerial vehicle may be used to take visual light and infrared images above a selected green infrastructure, and the images analyzed via the specialized apps, e.g., Canopeo/ArcMap, to obtain metrics such as plant density and plant health. See, U.S. patent application Ser. No. 18/734,702. For counting invasive plant numbers, a machine learning or deep learning module will be used to identify invasive plants among normal plants in the captured images. The deep learning module will focus on enhancing the invasive plant features to detect and count invasive plant species in the in-field images.

Soil performance metrics may be obtained with use of Turf-Tec double ring infiltrometers and Guelph disk infiltrometers to measure water infiltration and near-surface retention. Accessing pollutant removal performance and hydraulic control capacity may also be carried out according to the invention. Various native plant species and biosoil mixes/amendments can be examined for enhanced vegetation establishment and aiding soil function. Soil “bio” activity can be measured with simple methods to determine soil respiration, gauging CO₂ concentration and release, which may be affected by changes in air temperature, humidity, soil temperature, which would indicate bacterial activity necessary for nutrient reduction, as well as pollutant transformation, and metabolism. GI can be further appraised via seasonal observations and survey of system aesthetics, ecosystem services, and overall added value.

Collection of data can also be aggregated through a network through a communications system that can be placed in such a way to receive signals from remote sensors; e.g., via placement of a system with antenna on a rooftop to collect data from a number of sites within the range of the antenna.

Comprehensive evaluation of collected metric data preferably includes application of fuzzy logic. As noted above, fuzzy logic may be particularly useful in the identification and enumeration of invasive plant species. According to this embodiment, each metric/evaluation factor (e.g., plant density, plant health and invasive species count) may have three grades v1, v2, and v3, where v1 indicates that conditions are compromised and require key maintenance, v3 indicates that the conditions are relatively good, and v2 reflects that conditions are relatively satisfactory and require only scheduled maintenance.

The inspection and analysis results of evaluation factors will be used to determine the fuzzy relation matrix R=[r11, r21, r31; r12, r22, r32; . . . ; r1n, r2n, r3n].

Since every factor's status is not necessarily equal, a weighting coefficient may be applied, where a weight coefficient set (also referred to herein as the standards Matrix) A={a1, a2, . . . , an} represents the weight coefficient of every factor. As noted above, the quantitative standard value, weight coefficient A of each evaluation factor will be also obtained from expert consultation, scholars' research, and relative laws and regulations. See Table 2.

TABLE 2
Index Classification Standard and Weight
of the Evaluation Factors Index

| | Weight | Evaluation Grade V | | |
|---|---|---|---|---|
| Evaluation Index U | Coefficient A | v₁ | v₂ | v₃ |
| Plant Density | 0.35 | <30 | 30-70 | >70 |
| Plant Health | 0.47 | <0.25 | 0.25-0.65 | >0.65 |
| Invasive Plant Number | 0.18 | >10 | 1-10 | 0 |

Therefore, a comprehensive evaluation set, B is calculated as B=A×R={b1, b2, . . . , bn}. Overall green infrastructure performance may be scored using a score matrix S as good (90) for high grade, normal (50) for medium grade, and bad (10) for low grade. Thus, the final score of the selected green infrastructure will be calculated by multiplication of the evaluation set B and score matrix S. In addition, more comprehensive evaluation may be performed using the collected images to ensure functionality and effectiveness of the green infrastructure.

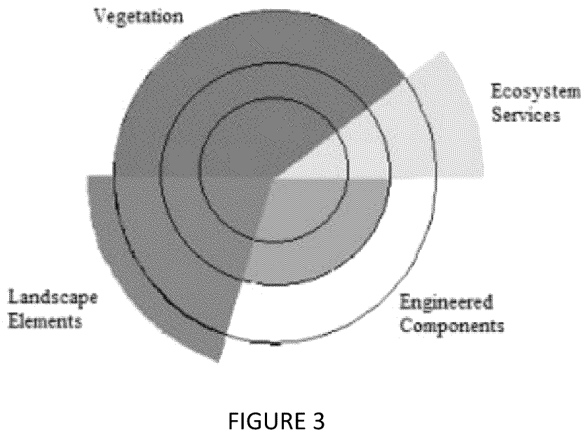

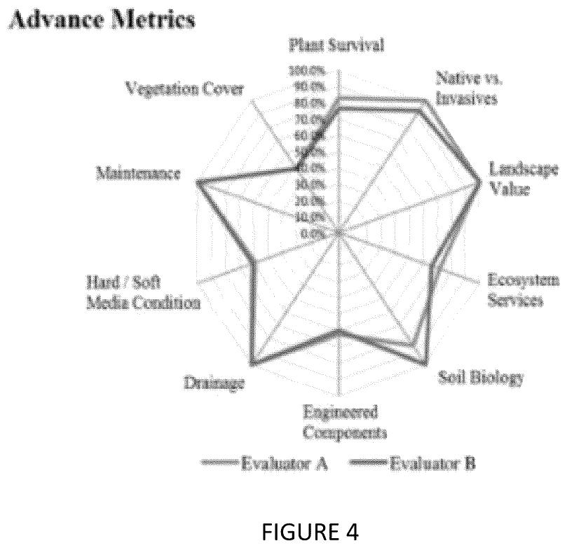

The data obtained from a wider and more reliable assessment of green infrastructures according to the invention will provide a fuller picture of their overall performance and appraisal of the value added to the urban setting. The assessment can be presented to the user any one or more ways, either in conjunction with each other or separately, for example: 1) with an appropriately selected data visualization that can depict vegetation, landscape elements, ecosystem services, or engineering components, see FIG. 3; or 2) through the use of advance metrics visualization, which measures vegetation cover, plant survival, native vs. invasive plants, landscape value, ecosystem services, soil biology, engineered components, drainage, media condition, and maintenance, see, FIG. 4.

Applications include determining plant density and health, evaluation of forests and agricultural areas, and as a means for decision making for engineering consultants and landscape architects/consultants and also benefit local and statement governments.

The present invention, therefore, is an innovative, efficient, economical, easy, rapid, and high accuracy inspection and evaluation system to generate a score for the GI instead of using the traditional manual check lists. GI include urban agriculture, green walls, urban woodlands, suburban street trees, sensitive urban design, green roofs, parks, gardens, golf courses, and city street trees. Based on the constructed database and calculated overall score, it can have multiple applications, including guidance to establish and implement GI performance verification protocols, adaptive management that assures desired long-term outcomes while reducing the uncertainty found in natural systems and human behaviors, and providing proper inspection and maintenance schedules to extend GI life cycle. Ultimately, it will improve new GIs' design and maintain existing GIs. In the long-term view, it can also be used as a decision-making model for engineering and landscape consultants and benefit local and state government.

1. A computer-implemented system for assessment of green infrastructure comprising:
a. an unmanned aerial vehicle (UAV) equipped with an image capture device,
b. a plurality of remote detection instruments located in one or more green infrastructures configured to detect one or more of air temperature, air humidity, air quality, air composition, soil composition, soil temperature, soil moisture, and soil pH,
c. a user interface,
d. a computing device in electronic communication with said UAV, said image capture device, and at least one of said plurality of detection instruments, said computing device comprising at least one processor and at least one non-transient memory,
e. a communications network to capture data from at least one of said plurality of remote sensors such that said sensors can transmit data collected by said at least one of said plurality of remote sensors to said computing device,
f. said non-transient memory comprising:
i. a standards database including
1. state and federal regulations pertaining to green infrastructures,
2. scientific publications pertaining to green infrastructures, and
3. a set of green infrastructure evaluation rules that associate green infrastructure metric conditions with a positive or negative effect on green infrastructure health,
ii. an image processing module including computer readable instructions which when executed by said at least one processor generate a raw plant health score and a raw plant density score,
iii. a moisture detection data processing module including computer readable instructions which when executed by said at least one processor generate a raw moisture score,
iv. a soil quality data processing module including computer readable instructions which when executed by said at least one processor generate a raw soil quality score,
v. an air quality data processing module including computer readable instructions which when executed by said at least one processor generate a raw air quality score,
vi. a score matrix S which relates a plurality of final green infrastructure scores to a corresponding set of green infrastructure evaluation sets,
vii. a green infrastructure improvement and maintenance database, including a set of green infrastructure improvement and maintenance rules that associate said green infrastructure evaluation sets and/or said final green infrastructure scores to a corresponding set of green infrastructure improvement and maintenance recommendations,
viii. a management module, including computer readable instructions which when executed by said at least one processor:
1. cause said user interface to prompt said user to enter one or more green infrastructures for evaluation,
2. cause said at least one processor to transmit a location for said selected green infrastructure to said image capture device,
3. cause said image capture device to transmit captured images to said image processing module,
4. cause said at least one of said plurality of remote detection instruments to transmit soil data to said soil detection data processing module,
5. cause said at least one of said plurality of remote detection instruments to transmit moisture data to said moisture detection data processing module,
6. cause said at least one of said plurality of remote detection instruments to transmit air quality data to said air quality data processing module,
7. calculates a weighted green infrastructure evaluation matrix B using said raw plant health score, said raw plant density score, said raw moisture score and said raw soil quality score, said raw air quality score and said standards database,
8. assigns a green infrastructure score using said green infrastructure evaluation matrix and said score matrix S,
9. transmits or displays said green infrastructure score to a user device,
10. transmits or displays to said user device one or more of said green infrastructure improvement and maintenance recommendations.

2. The computer-implemented system of claim 1, wherein said computing device comprises a network of distributed processors and non-transient memories.

3. The computer implemented system of claim 1, wherein said electronic communication is wireless.

4. The computer implemented system of claim 1, wherein said communications network is wireless.
